(19) United States
(12) Patent Application Publication
(10) Pub. No.: US 2015/0231425 A1
(43) Pub. Date: Aug. 20, 2015

(54) BELT-TYPE FALL DAMPER

(71) Applicant: SKYLOTEC GMBH, Neuwied (DE)

(72) Inventors: Robert Krueger, Bad Tolz (DE); Allessandro Accogli, Cadenazzo TI (CH)

(21) Appl. No.: 14/434,122

(22) PCT Filed: Jun. 25, 2014
(86) PCT No.: PCT/EP2014/063366

§ 371 Date: Apr. 8, 2015

(30) Foreign Application Priority Data
Jul. 11, 2013 (DE) 20 2013 103 0929

(51) Int. Cl. A62B 35/04; A62B 35/00

(52) U.S. Cl. CPC A62B 35/04; A62B 35/0037

(57) ABSTRACT

The invention relates to a belt-like fall impact absorber for braking a falling mass, comprising at least four belts (1, 2, 3, 4), wherein at least two belts (1, 2) are arranged adjacently to one another in a first layer (5) and at least two belts (3, 4) are arranged adjacently to one another in a second layer (6), the beginnings of the belts (1, 2) of the first layer (5) are connected (A) to the ends of the belts (3, 4) of the second layer (6), and the beginnings of the belts (3, 4) of the second layer (6) are connected (B) to the ends of the belts (1, 2) of the first layer (5), and on the one hand the belts (1, 2, 3, 4) of the first and/or second layer (5, 6) and on the other hand the first and second layer (5, 6) can be interconnected, in each case alternately, such that they can tear open.

### REFERENCE TO RELATED APPLICATIONS

This application is the U.S. national stage application of International Patent Application No. PCT/EP2014/063366, filed Jun. 25, 2014, which claims priority of German Application No. 20 2013 103 0929, filed Jul. 11, 2013, which are both hereby incorporated by reference.

### BACKGROUND

The invention relates to a belt-type fall impact absorber for braking a falling mass, comprising at least four belts, wherein at least two belts are arranged adjacently to one another in a first layer and at least two belts are arranged adjacently to one another in a second layer, and the beginnings of the belts of the first layer are connected to the ends of the belts of the second layer and the beginnings of the belts of the second layer are connected to the ends of the belts of the first layer. The invention also relates to a double belt-type fall impact absorber for braking a falling mass, comprising at least two belts, wherein the beginning of a first belt is connected to the end of a second belt and the beginning of the second belt is connected to the end of the first belt.

Various braking systems are known from the prior art in order to brake a falling mass. A falling mass is generally a falling person, typically a rock climber, mountain climber or façade climber. A distinction is made among the braking systems between various basic types, for example the widespread dynamic brakes, which reduce the falling speed of the falling person by elastic stretching of a dynamic rope or spring element. Here, the falling speed is reduced by friction enforced at perforated plates or buckles or by only slightly stretchable ropes or belts. Further, what are known as tear-open brakes are known, in which the energy of a fall is reduced by the tearing open of a connection in the braking system.

A disadvantage however with constructions of this type, also referred to as belt-type fall impact absorbers, is that they only intervene in one phase and are only optimally triggered from a certain body weight of the falling person. Tests have revealed that in the case of lighter falling people in particular, there is a disproportionately higher loading and therefore even more serious risk of injury.

Specifically, the belt-type fall impact absorbers known from the prior art in particular for children between 15 kg and 30 kg body weight offer only an insufficient braking effect, such that, depending on the falling position and rope method, injuries to the cervical and thoracic spine, such as whiplash and spinal and neck fractures, can occur due to the accelerations caused in the case of a fall. In the worst case, in the event of falls of children secured by the belt-type fall impact absorbers known from the prior art, inner acceleration and deceleration injuries such as contusions of the internal organs occur, which may even result in death.

### SUMMARY

The object of the present invention is therefore to specify a belt-type fall impact absorber which, in particular in the case of a falling child, considerably reduces the force of impact of the falling person compared to the systems known from the prior art.

The object is achieved in accordance with the invention by the features of the independent claims. Advantageous embodiments of the invention are specified in the dependent claims.

The object is therefore achieved by a belt-type fall impact absorber for braking a falling mass, comprising at least four belts, wherein at least two belts are arranged adjacently to one another in a first layer and at least two belts are arranged adjacently to one another in a second layer, the beginnings of the belts of the first layer are connected to the ends of the belts of the second layer and the beginnings of the belts of the second layer are connected to the ends of the belts of the first layer, and on the one hand the belts of the first layer and/or second layer and on the other hand the first and second layer are interconnected, in each case alternately, such that they can tear open.

A key point of the invention is thus that, on the basis of the example of precisely four belts, on the one hand two belts of a layer are interconnected such that they can tear open and on the other hand both layers formed in each case by two belts are also interconnected such that they can tear open, in each case alternately. The connection between the belts is preferably established by what is known as a braking seam, which, in accordance with the embodiment according to the invention, first continuously interconnects the belts of the first layer, then interconnects the two layers, then interconnects the belts of the second layer in order to then lastly interconnect the two layers again. A falling mass, preferably the falling person, is then braked by separation of the aforementioned braking seam.

As a result, a controlled tearing open of the two layers is achieved as a result of the multi-layer construction according to the invention, such that the reduction of force during the braking of the falling mass is controlled in a checked manner. Specifically, a stepped progressive reduction of force is achieved by the alternating respective connection of the belts of one layer to one another and of the two layers to one another, wherein the reduction of force can be controlled in detail by the type of respective connection of the belts of a layer to one another and also of the two layers to one another. Due to the resultant stepped damping, the forces of impact in the case of a fall are considerably reduced compared with the belt-type fall impact absorbers known from the prior art, such that people with only 30 kg body weight, such as children, can also be protected optimally.

In accordance with a preferred embodiment, the belts of the first and/or second layer and/or the first and second layer are in each case sewn to one another, adhesively bonded to one another and/or interwoven alternately. Here, the belts can be interwoven in the same process step during production of the belts themselves, which leads to favourable production costs. In the case of sewing, it is preferable for the seam, which is also referred to as a braking seam within the scope of this application, to interconnect continuously first the two belts of the first layer, and in the case of four belts then to interconnect the two layers, then the two belts of the second layer and lastly the two layers again. The sewing is even more preferably performed continuously along the extension of the belts resting adjacently to one another and contacting one another.

In this context it is particularly preferable if on the one hand the belts of the first and/or second layer and on the other hand the first and second layer are interconnected by a continuous “VW” attachment. An embodiment of this type leads to greater safety margins compared with the belt-type fall impact absorbers known from the prior art on account of the multi-layer anchoring of the four belts, which are formed in each case by two layers. A key advantage of a “VW” attachment of this type is that steps are produced by the respective embodiment of the V attachment and also the W attachment, and the reduction of force in the case of a fall can be managed in a controlled manner due to the height and length of said steps.

The belts may be formed arbitrarily in principle, preferably as webbings known from the field of climbing. In accordance with a particularly advantageous embodiment however, the belts comprise polyester and/or polyamide and/or the belts have a width of ≧30 mm and ≦45 mm. Polyester belts with preferably 43 mm are characterised by a lower moisture absorption compared with polyamide, which leads to a preservation of the dynamic performance, in particular during braking. On the other hand, the embodiment according to the invention with at least four belts also allows the use of polyamide belts with 30 mm width, since sufficient safety margins are provided by the four individual belts, such that there is no risk of total failure of the belt-type fall impact absorber in wet conditions. In addition, the embodiment according to the invention with at least four belts, which are each provided in two individual layers and therefore are arranged in four layers on the whole, leads to higher static end strengths compared with embodiments known from the prior art with just two layers.

In accordance with a further embodiment, it is preferable that the ends of the belts of the first layer are twisted from the beginnings thereof by a half revolution and the ends of the belts of the second layer are twisted from the beginnings thereof by a half revolution, and the direction of rotation is selected in each case such that an untwisted, parallel arrangement of the belts can be produced when the belts are torn open completely. Due to an embodiment of this type, a problem-free tearing open of the belts in the case of a fall is supported.

It is also preferable if the beginnings of the belts of the first layer are connected to the ends of the belts of the second layer and the beginnings of the belts of the second layer are connected to the ends of the belts of the first layer, in each case non-detachably, for example are fixedly sewn to one another. Even more preferably, the beginnings of the belts of the first layer are connected to the ends of the belts of the second layer and the beginnings of the belts of the second layer are connected to the ends of the belts of the first layer in such a way that two loops for connection to a fixed securing point and/or to the mass are produced. In this context, it is also preferable for one loop to have a karabiner for connection to the fixed securing point and for the other loop to have an eyelet and/or a noose for connection to the mass. A karabiner can also be provided on the eyelet for connection to the mass, preferably the person to be secured.

In a further embodiment it is preferable if the belts are interconnected, such that they can tear open, in each case along a braking zone, which extends between two tear-open fronts arranged adjacently to the connections of the belts. Due to the length of the braking zone, the number of “connection points” of the two belts of a layer to one another and also of the two layers to one another can define aforementioned steps, by means of which, compared to the embodiments known from the prior art, the checked tearing open of the belts according to the invention in the case of a fall in the belt-type fall impact absorber can be managed in detail and therefore can be controlled, in each case starting at the tear-open fronts.

In accordance with a further embodiment, the braking zone preferably has a loop in which the belts are not interconnected. Due to the loop, the mechanical loading of the belts when the tear-open fronts of the layers or belts meet, starting from the respective tear-open fronts originally delimiting the braking zone and moving in the direction of the loop on account of the tearing open, does not exceed the loading limits of the belts as a whole, and therefore the risk of the belts tearing due to shear forces is eliminated.

In accordance with an even more preferred embodiment, the belts of the first layer are first interconnected repeatedly in the direction of extension of the belts, then the first layer and the second layer are interconnected, then the belts of the second layer are interconnected and lastly the first layer and the second layer are interconnected. The above-mentioned schema, which specifically also corresponds to the “VW” attachment, continues repeatedly along the direction of extension of the belts, for example after 2 cm, 5 cm or 10 cm in each case.

In particular, in the case of a “VW” attachment, there are more preferably a number of “VW” attachments parallel to one another in the direction of extension of the belts, wherein in each case the different “VW” attachments are arranged parallel to one another in such a way that the different parallel “VW” attachments interconnect the two belts of the first layer at one point, the different parallel “VW” attachments interconnect the first layer and the second layer at a second point, the different parallel “VW” attachments interconnect the belts of the second layer at a third point, and the different parallel “VW” attachments interconnect the two layers at a fourth point. In contrast to the above-mentioned embodiment, the different “VW” attachments can also be arranged offset in relation to one another.

The object of the invention is also achieved by a double belt-type fall impact absorber for braking a falling mass, comprising at least two belts, wherein the beginning of a first belt is connected to the end of a second belt and the beginning of the second belt is connected to the end of the first belt and the belts are interconnected by a “VW” attachment, such that they can tear open, along a braking zone, which extends between the respective connection. The two belts can thus tear open in a controlled manner, which leads to a progressive reduction of force and therefore safe and dedicated interception of the falling mass.

Further embodiments of the double belt-type fall impact absorber will be clear to a person skilled in the art in analogy to the previously described belt-type fall impact absorber.

The invention will be explained in greater detail hereinafter with reference to the accompanying drawing on the basis of a preferred embodiment.

### BRIEF DESCRIPTION OF THE DRAWINGS

FIG. 1 shows a belt-type fall impact absorber in accordance with a preferred embodiment of the invention in a perspective plan view,

FIG. 2 shows four belts of the belt-type fall impact absorber in accordance with the preferred exemplary embodiment of the invention in a sectional view,

FIG. 3 shows two belts of a belt-type fall impact absorber known from the prior art in a sectional view,

FIG. 4 shows a force/time graph when the belt-type fall impact absorber illustrated in FIG. 2 in accordance with the preferred exemplary embodiment of the invention tears open,

FIG. 5 shows a force/time graph when the belt-type fall impact absorber illustrated in FIG. 3 and known from the prior art tears open, and

FIG. 6 shows two belts of the belt-type fall impact absorber in accordance with a further preferred exemplary embodiment of the invention in a sectional view.

### DETAILED DESCRIPTION OF THE DRAWINGS

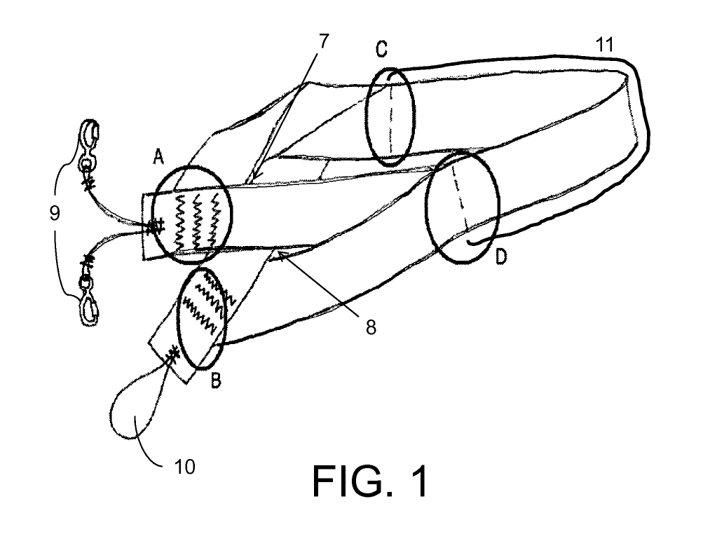

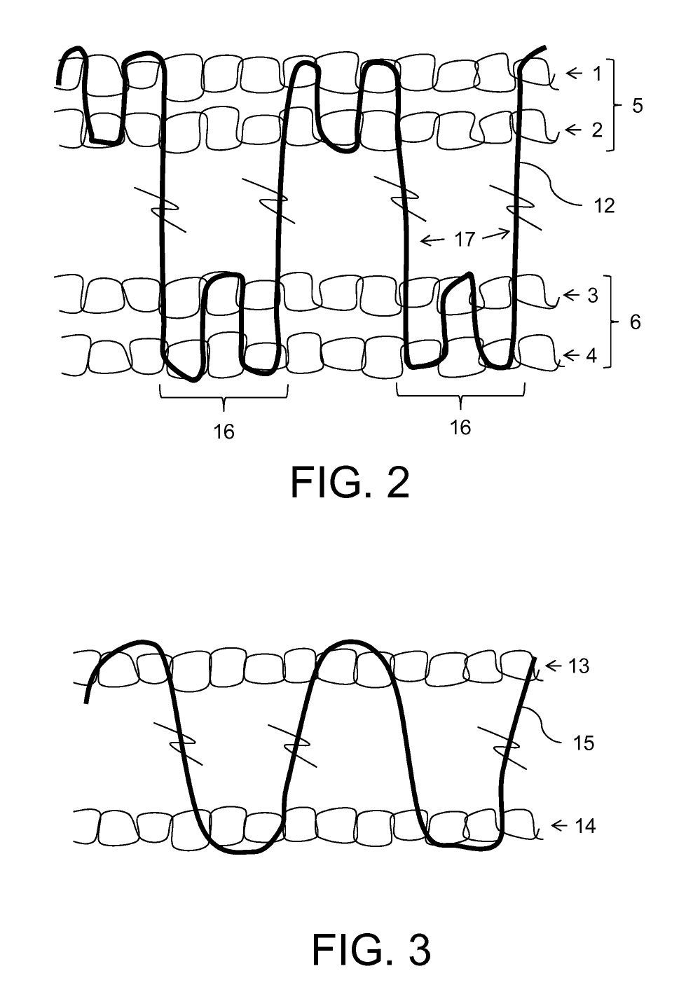

FIG. 1 shows a belt-type fall impact absorber for braking a falling mass in accordance with a preferred exemplary embodiment of the invention in a perspective plan view. The belt-type fall impact absorber has four belts 1, 2, 3, 4, which in FIG. 2 are illustrated in a sectional view. The four belts 1, 2, 3, 4 are made of polyester and have a width of 43 mm. Alternatively, the belts 1, 2, 3, 4 may also be made of polyamide with a width of 30 mm.

Compared with polyamide, polyester is characterised by a lower moisture absorption and, in comparison, offers an improved dynamic performance in the event of a fall. On the other hand however, a 4-layer embodiment of this type with 4 polyamide belts 1, 2, 3, 4 offers sufficient safety margins compared with embodiments known from the prior art with just two belts 13, 14, as shown in FIG. 3, even in the presence of moisture, and therefore there is no risk of total failure in the event of a fall.

In each case, two belts 1, 2, 3, 4 are arranged with their belt faces adjacent to one another and resting against one another to form a first layer 5 and also a second layer 6. As can be seen in detail from FIG. 1, the beginnings of the belts 1, 2 of the first layer 5 are connected to the ends of the belts 3, 4 of the second layer 6 and the beginnings of the belts 3, 4 of the second layer 6 are connected to the ends of the belts 1, 2 of the first layer 5 at the points denoted A and B, specifically are sewn in each case.

Here, the connections denoted by A and B are formed in such a way that two loops 7, 8 are produced, wherein the loop 7 is inseparably connected via the connection point A to two karabiners 9 and the loop 8 is undetachably connected via the connection point B to an eyelet 10. Whereas the karabiners 9 can be connected to a fixed securing point, for example a climbing route, a mass to be secured, in particular a person such as a child, can be connected via the eyelet 10.

As already mentioned, the belts 1, 2, 3, 4 rest along the belt faces thereof in contact with one another between the tear-open fronts denoted C and D, provided no tearing open has taken place in the case of a fall. In accordance with the invention, as can be seen in detail from FIG. 2, the four belts 1, 2, 3, 4 are now sewn to one another, such that they can tear open, by means of a continuous “VW” attachment 12 between a breaking zone 11 delimited by the tear-open fronts C and D.

This means that, in the case of a fall in the belt-type fall impact absorber, the “VW” attachment 12 can tear open both from the tear-open front denoted C and from the tear-open front denoted D, such that the energy of the fall is reduced in a stepped manner by the continued tearing open of the “VW” attachment 12. To this end, the “VW” attachment 12 interconnects the two belts 1, 2 of the first layer 5 a number of times by means of a “W” attachment 16, as can be seen in detail from FIG. 2, before the continuous thread transitions at a point marked by the “lightning bolt” from the first layer 5 to the second layer 6 by means of a “V” attachment 17 and thus interconnects the two layers 5, 6.

The thread then connects the two belts 3, 4 of the second layer 6 to one another a number of times by means of a “W” attachment 16, before the continuous thread then transitions at a further point marked by the “lightning bolt” from the second layer 6 to the first layer 5 by means of a “V” attachment 17. This type of connection, which can also be achieved by appropriate interweaving of the belts 1, 2, 3, 4 and/or additionally can be supported by adhesive bonding of the belts 1, 2, 3, 4, is repeated along the braking zone 11. Although in FIG. 2 only one continuous thread is shown by way of example as a “VW” attachment 12, a plurality of parallel “VW” attachments 12 are preferably provided. It is equally possible, instead of being formed by a seam, by adhesive bonding and/or interweaving, for the “VW” attachment 12 also to be formed by a combination of the aforementioned or comparable embodiments.

Compared with the belt-type fall impact absorbers known from the prior art and shown in FIG. 3, which have just two belts 13, 14, which are interconnected by a single seam 15, and in this respect have only low safety margins and virtually no manageability when the single seam 15 tears open, since there is a purely degressive force reduction, the embodiment according to the invention has significant advantages. This is because the multi-layer construction consisting of at least four belts 1, 2, 3, 4 which are arranged in two layers 5, 6 and which are sewn to one another by the “VW” attachment 12 illustrated in FIG. 2 achieve a controlled tearing open of the “VW” attachment 12, such that, even with light masses to be secured, such as the typical weight of children between 15 kg and 30 kg, a stepped damping of a fall is made possible, such that the forces of impact acting on the falling person thus can be enormously reduced compared with the embodiments known from the prior art and shown in FIG. 3.

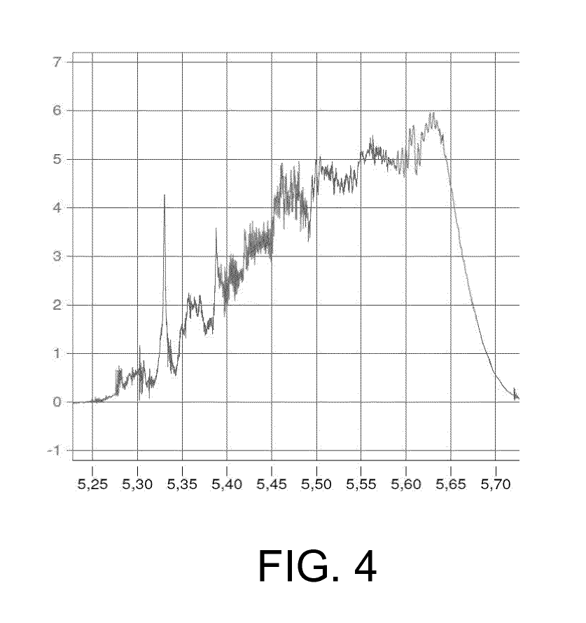

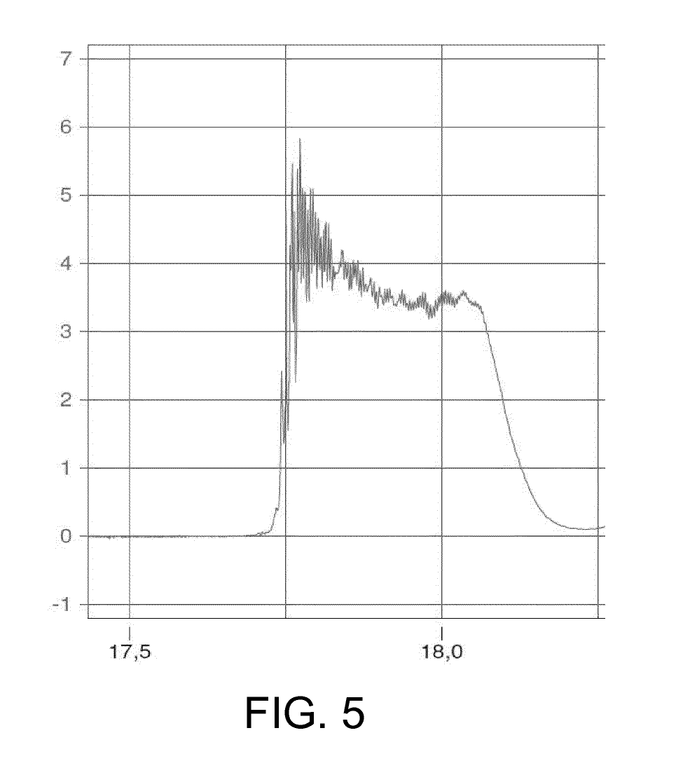

This is illustrated in the force/time graphs in FIGS. 4 and 5, wherein FIG. 4 shows the force/time graph of a belt-type fall impact absorber in accordance with the invention and FIG. 5 shows the force/time graph of a belt-type fall impact absorber of the prior art. In each case the test result force in kN is plotted over time in seconds in the case of a fall height of 400 cm and a weight of 100 kg.

It can be seen from FIG. 4 that the “VW” attachment 12 tears open in steps, wherein the height and length of the steps is dependent on the specific embodiment of the heights and steps of the “VW” attachment 12, that is to say the respective “V” attachment 17, the “W” attachment 16 and also the number of attachments 16, 17 per section. It is thus possible to control whether the force reduction in the case of a fall is progressive or degressive. Specifically, in the test illustrated in FIG. 4, 8 steps of the “VW” attachment 12 were torn open, which can also be seen accordingly.

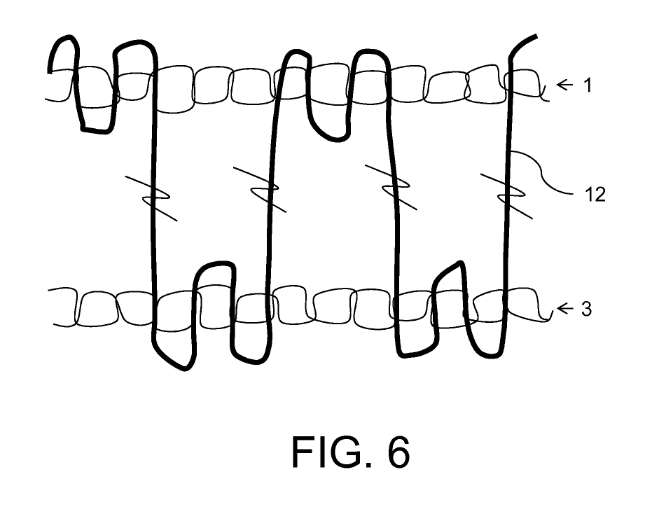

It is also possible, in accordance with a further embodiment illustrated in FIG. 6, to transfer the principle of the “VW” attachment 12 to just a two-layer embodiment comprising just two belts 1, 3. In this case, the “W” attachment 16 only encompasses a single belt 1, 3 a number of times, and the “V” attachment 17 connects the two belts 1, 3 to one another.

As a result, the multi-layer anchoring of the four belts 1, 2, 3, 4 in accordance with the connection according to the invention by means of “VW” attachment 12 leads to a greater safety margin compared with the systems known from the prior art and, in the case of a fall, leads to an uncontrolled tearing open, such that a stepped damping and therefore a more gentle impact force thus result.

### LIST OF REFERENCE SIGNS

belt 1, 2, 3, 4
first layer 5
second layer 6
loop 7, 8
karabiner 9
eyelet 10
braking zone 11
“VW” connection 12
belt 13, 14
seam 15
“W” attachment 16
“V” attachment 17
connection A, B
tear-open front C, D

1. A belt-type fall impact absorber for braking a falling mass, comprising at least four belts (1, 2, 3, 4), wherein
at least two belts (1, 2) are arranged adjacently to one another in a first layer (5) and at least two belts (3, 4) are arranged adjacently to one another in a second layer (6),
the beginnings of the belts (1, 2) of the first layer (5) are connected (A, B) to the ends of the belts (3, 4) of the second layer (6) and the beginnings of the belts (3, 4) of the second layer (6) are connected to the ends of the belts (1, 2) of the first layer (5), and
on the one hand the belts (1, 2, 3, 4) of the first and/or second layer (5, 6) and on the other hand the first and second layer (5, 6) are interconnected, in each case alternately, such that they can tear open.

2. The belt-type fall impact absorber according to the preceding claim, wherein the belts (1, 2, 3, 4) of the first and/or second layer (5, 6) and/or the first and second layer (5, 6) are in each case sewn to one another, adhesively bonded to one another and/or interwoven alternately.

3. The belt-type fall impact absorber according to claim 1, wherein on the one hand the belts (1, 2, 3, 4) of the first and/or second layer (5, 6) and on the other hand the first and second layer (5, 6) are interconnected by a continuous “VW” connection (12).

4. The belt-type fall impact absorber according to claim 1, wherein the belts (1, 2, 3, 4) comprise polyester and/or polyamide and/or the belts have a width of ≧30 mm and ≦45 mm.

5. The belt-type fall impact absorber according to claim 1, wherein the ends of the belts (1, 2) of the first layer are twisted from the beginnings thereof by a half revolution and the ends of the belts (3, 4) of the second layer (6) are twisted from the beginnings thereof by a half revolution, and the direction of rotation is selected in each case such that, when the belts (1, 2, 3, 4) tear open completely, an untwisted, parallel arrangement of the belts (1, 2, 3, 4) can be produced.

6. The belt-type fall impact absorber according to claim 1, wherein the beginnings of the belts (1, 2) of the first layer (5) are connected to the ends of the belts (3, 4) of the second layer (6) and the beginnings of the belts (3, 4) of the second layer (6) are connected to the ends of the belts (1, 2) of the first layer (5) in such a way that two loops (7, 8) for connection to a fixed securing point and/or to the mass are produced.

7. The belt-type fall impact absorber according to claim 1, wherein one loop (7) has a karabiner (9) for connection to the fixed securing point and the other loop (8) has an eyelet and/or a noose for connection to the mass.

8. The belt-type fall impact absorber according to claim 1, wherein the belts (1, 2, 3, 4) are interconnected, such that they can tear open, in each case along a braking zone (11), which extends between two tear-open fronts (C, D) arranged adjacently to the connections (A, B) of the belts (1, 2, 3, 4).

9. The belt-type fall impact absorber according to claim 8, wherein the braking zone (11) has a loop in which the belts (1, 2, 3, 4) are not interconnected.

10. The belt-type fall impact absorber according to claim 1, wherein, in the direction of extension of the belts (1, 2, 3, 4), the belts (1, 2) of the first layer (5) are first interconnected repeatedly, then the first layer (5) and the second layer (6) are interconnected, then the belts (3, 4) of the second layer (6) are interconnected, and lastly the first layer (1, 2) and the second layer (5, 6) are interconnected.

11. A double belt-like fall impact absorber for braking a falling mass, comprising at least two belts (1, 3), wherein
the beginning of a first belt (1) is connected (A) to the end of a second belt (3) and the beginning of the second belt (3) is connected (B) to the end of the first belt (1), and
the belts (1, 3) are interconnected by a “VW” attachment (12), such that they can tear open, along a braking zone (11), which extends between the respective connection (A, B).

12. The belt-type fall impact absorber according to claim 2, wherein on the one hand the belts (1, 2, 3, 4) of the first and/or second layer (5, 6) and on the other hand the first and second layer (5, 6) are interconnected by a continuous “VW” connection (12).

13. The belt-type fall impact absorber according to claim 12, wherein the belts (1, 2, 3, 4) comprise polyester and/or polyamide and/or the belts have a width of ≧30 mm and ≦45 mm.

14. The belt-type fall impact absorber according to claim 13, wherein the ends of the belts (1, 2) of the first layer are twisted from the beginnings thereof by a half revolution and the ends of the belts (3, 4) of the second layer (6) are twisted from the beginnings thereof by a half revolution, and the direction of rotation is selected in each case such that, when the belts (1, 2, 3, 4) tear open completely, an untwisted, parallel arrangement of the belts (1, 2, 3, 4) can be produced.

15. The belt-type fall impact absorber according to claim 14, wherein the beginnings of the belts (1, 2) of the first layer (5) are connected to the ends of the belts (3, 4) of the second layer (6) and the beginnings of the belts (3, 4) of the second layer (6) are connected to the ends of the belts (1, 2) of the first layer (5) in such a way that two loops (7, 8) for connection to a fixed securing point and/or to the mass are produced.

16. The belt-type fall impact absorber according to claim 15, wherein one loop (7) has a karabiner (9) for connection to the fixed securing point and the other loop (8) has an eyelet and/or a noose for connection to the mass.

17. The belt-type fall impact absorber according to claim 16, wherein the belts (1, 2, 3, 4) are interconnected, such that they can tear open, in each case along a braking zone (11), which extends between two tear-open fronts (C, D) arranged adjacently to the connections (A. B) of the belts (1, 2, 3, 4).

18. The belt-type fall impact absorber according to claim 17, wherein the braking zone (11) has a loop in which the belts (1, 2, 3, 4) are not interconnected.

19. The belt-type fall impact absorber according to claim 18, wherein, in the direction of extension of the belts (1, 2, 3, 4), the belts (1, 2) of the first layer (5) are first interconnected repeatedly, then the first layer (5) and the second layer (6) are interconnected, then the belts (3, 4) of the second layer (6) are interconnected, and lastly the first layer (1, 2) and the second layer (5, 6) are interconnected.

20. The belt-type fall impact absorber according to claim 9, wherein, in the direction of extension of the belts (1, 2, 3, 4), the belts (1, 2) of the first layer (5) are first interconnected repeatedly, then the first layer (5) and the second layer (6) are interconnected, then the belts (3, 4) of the second layer (6) are interconnected, and lastly the first layer (1, 2) and the second layer (5, 6) are interconnected.
